(19) United States
(12) Patent Application Publication
(10) Pub. No.: US 2008/0272529 A1
(43) Pub. Date: Nov. 6, 2008

(54) Jounce bumpers made by corrugated extrusion

(76) Inventors: Christophe Chervin, Neydens (FR); Peter L. Szekely, Pringy (FR); Thierry Donis, Paris (FR); Damien Van-Der-Zyppe, Champigny sur MaRNE (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/150,833

(22) Filed: May 1, 2008

Related U.S. Application Data
(60) Provisional application No. 60/927,062, filed on May 1, 2007.

(51) Int. Cl. B60G 13/00; B29D 23/00

(52) U.S. Cl. 267/201; 264/46.1

(57) ABSTRACT

The invention provides vehicle suspension systems, and more particularly jounce bumpers made by corrugated extrusion.

### CROSS REFERENCE TO RELATED APPLICATIONS

This application claims the benefit of priority to U.S. Provisional Application No. 60/927,062, filed May 1, 2007.

### FIELD OF INVENTION

The present invention relates to the field of vehicle suspension systems, and more particularly to jounce bumpers.

### BACKGROUND OF THE INVENTION

A jounce bumper (also called bump stop, end-of-travel bumper, strike-out bumper, suspension bumper, or compression bumper) is a shock-absorbing part on the top of vehicle suspensions. Jounce bumpers for use in motor vehicle suspension systems have long been used for cushioning the impact between two suspension system components, such as the axle and a portion of the frame, as well as attenuating noise and vibration for the ride comfort of the passengers. Since displacement of the vehicle chassis causes displacements of the strut, the strut undergoes cycles of compression and extension in response to the displacement of the vehicle chassis. Provision must be made for protecting the strut assembly and the vehicle body from the jounce forces associated with severe irregularities in the road surface leading to extreme displacement of the suspension. For this reason, a jounce bumper is attached to the suspension system at a point where impact is likely to occur when the shock absorber fails to absorb the forces created by extraordinary driving conditions. Particularly, during jounce motions of the strut, the damper “bottoms out” and the jounce bumper moves into contact with the jounce bumper plate and compresses to dissipate energy resulting in cushioning the impact, reducing noise, reducing the feel of impact to the passengers and reducing possible damage to the vehicle suspension system. Jounce bumpers are elongated, generally cylindrical, members with or without convolutes, made of a compressible and elastomeric material that extends around the piston rod. Materials suitable for this application must be resilient, i.e. capable of withstanding shock without permanent deformation or rupture, and must have excellent flex life. Conventional jounce bumpers are made from polyurethanes and copolyester polymers. A typical jounce bumper made of an elastomeric material is shown in FIG. 1.

Jounce bumpers are conventionally formed of polyurethane and especially microcellular polyurethane (MCU). A microcellular polyurethane jounce bumper is made by casting polyurethane precursors in a jounce bumper mold. Microcellular foam is obtained from the reaction of diisocyanate glycol with a blowing agent or with water which produce carbon dioxide gas for foaming. This technology is time-consuming since foaming requires prolonged times in the mold due to the slow release of carbon dioxide. While jounce bumpers made of foamed polyurethane have good ride characteristics, they are expensive to produce since they require a time-consuming technology.

With the aim of improving durability, inertness to automotive fluids, resistance to tear propagation of the material used to form the jounce bumper, U.S. Pat. No. 5,192,057 discloses an elongated hollow body formed of an elastomer and preferably from a copolyetherester polymer. Such pieces are manufactured by blow molding techniques.

Blow molding is a conventional technique used for manufacturing hollow plastic articles. Typically a parison of plastic material that has been produced by extrusion or injection molding and which is in a hot moldable condition is positioned between two halves of an open blow mold having a mold cavity of a shape appropriate to the required external shape of the article to be manufactured. The parison gradually descends and stretches under the influence of gravity. When the parison reaches the proper length, the mold halves are closed around it and pressurized air or other compressed gas is introduced in the interior of the parison to inflate it to the shape of mold or to expand it against the sides of the mold cavity. After a cooling period, the mold is opened and the final article is ejected.

In extrusion blow molding, the parison is produced by extruders. Extrusion blow molding is less expensive than foaming/casting but leads to less precise dimensions and leads also to limitations in the wall thickness of the part. The stiffness of a jounce bumper is directly related to its thickness. Thus, a small variation of thickness (either variation from article to article, along the longitudinal axle of a jounce bumper made from one shot, or along the radius of the convolute of a jounce bumper made in a single jounce bumper), like for example 0.2 mm, will significantly change the stiffness of the jounce bumper and its energy absorption capacity and dampening performance.

Injection blow molding gives more precise dimensions than extrusion blow molding. In this technique, the parison is formed by injection molding, the inner core of the mold is removed and the parison is quickly inflated while being enclosed in two mold halves as in extrusion blow molding. The parison can be injection molded to have a non-constant cross-section resulting in a better wall thickness uniformity of the final part than from extrusion blow molding. Injection blow molding allows more precise details in the final blown structure but is more expensive than extrusion blow molding.

There is a current need to find a way to easily manufacture jounce bumpers efficiently and economically.

### SUMMARY OF THE INVENTION

The inventors have found that jounce bumpers having well defined and controlled dimensions and excellent performance characteristics can be economically made by corrugated extrusion.

In a first aspect, the invention provides a jounce bumper made of a thermoplastic elastomer, which thermoplastic elastomer has an apparent viscosity higher than 275 Pa·s measured according to ISO 11443:2005(E) under a shear rate of 1000 s⁻¹ and at a processing temperature at or about 30° C. above the polymer melting point.

In a second aspect, the invention provides a process for manufacturing a jounce bumper using corrugated extrusion.

### BRIEF DESCRIPTION OF THE DRAWINGS

FIG. 1 is a schematic broken view of a jounce bumper. Line A-B designates the symmetry axis of the jounce bumper.

FIG. 2 is a schematic broken view of a jounce bumper comprising all parameters describing the jounce bumper. Line A-B designates the symmetry axis of the jounce bumper, T designates the thickness, P designates the pitch, a) designates a peak, b) designates a valley, Rᵢₙₜ designates the diameter of the valley, Rₒᵤₜ designates the diameter of the peak, rc designates the fillet radius at minimum outer diameter of bellows, and rs designates the fillet radius at maximum outer diameter of bellows.

FIG. 3 is a schematic broken view of a multilayer jounce bumper. Line A-B designates the symmetry axis of the multilayer jounce bumper, a designates the outer layer of the multilayer jounce bumper and b designates the inner layer of the multilayer jounce bumper.

FIG. 4 is a compression curve of a jounce bumper made of a copolyetherester manufactured by corrugated extrusion. The x-axis is deflection (D) in mm and the y-axis is force (F) in N.

### DETAILED DESCRIPTION OF THE INVENTION

All documents referred to herein are incorporated by reference.

Corrugated extrusion consists of extruding a hollow tube of material from an extrusion die, and manipulating the hollow tube usually in a mold, so as to cause the formation of circumferential corrugations, bellows or convolutes. The hollow tube of material may be shaped into a jounce bumper article either by heated air or by vacuum expansion against the surface of the mold cavity. The process for manufacturing a jounce bumper according to the present invention comprises the steps of:
a) feeding a molten plastic material into an extruder;
b) extruding the plastic material, which is in a hot moldable condition, through the pin and the die of an extrusion head to form a hollow continuous tube;
c) corrugating the hollow continuous tube; and
d) cutting the chain of multiple jounce bumpers to form single and discrete jounce bumpers;
or rolling up the continuous corrugated tube of multiple jounce bumpers for storage, and cutting at a later stage.

A preferred method of corrugated extrusion is vacuum corrugated extrusion which consists of the following steps:
a) feeding a molten plastic material into an extruder;
b) extruding the plastic material, which is in a hot moldable condition, through the pin and the die of an extrusion head to form a hollow continuous tube;
c) passing the hollow continuous tube into the mold blocks and drawing up and vacuum expanding the molten material against the mold cavity surface or the corrugator,
d) cutting cross-wise the continuous corrugated tube of multiple jounce bumpers to form single and discrete jounce bumpers;
or rolling up the continuous corrugated tube of multiple jounce bumpers for storage, and cutting at a later stage.

The corrugating machine includes a mold tunnel made of two sets of exchangeable and complementary mold assemblies comprising a chain of interconnected mold blocks, which mold blocks are continuously cooled by water. The mold blocks continuously move on conveyor tracks versus the pin and the die head, which allows a continuous production of jounce bumpers at a rather elevated speed. For example, blow molding methods allow the manufacture of about 4 jounce bumpers per minute whereas corrugated extrusion permits the manufacture at a much faster rate (e.g. more than 20, or 40 jounce bumpers per minute). Corrugated extrusion may be done by using a machine manufactured by Corelco (France). The machine and the method are disclosed in EP 0909629 and EP 0734 835, which are incorporated by reference.

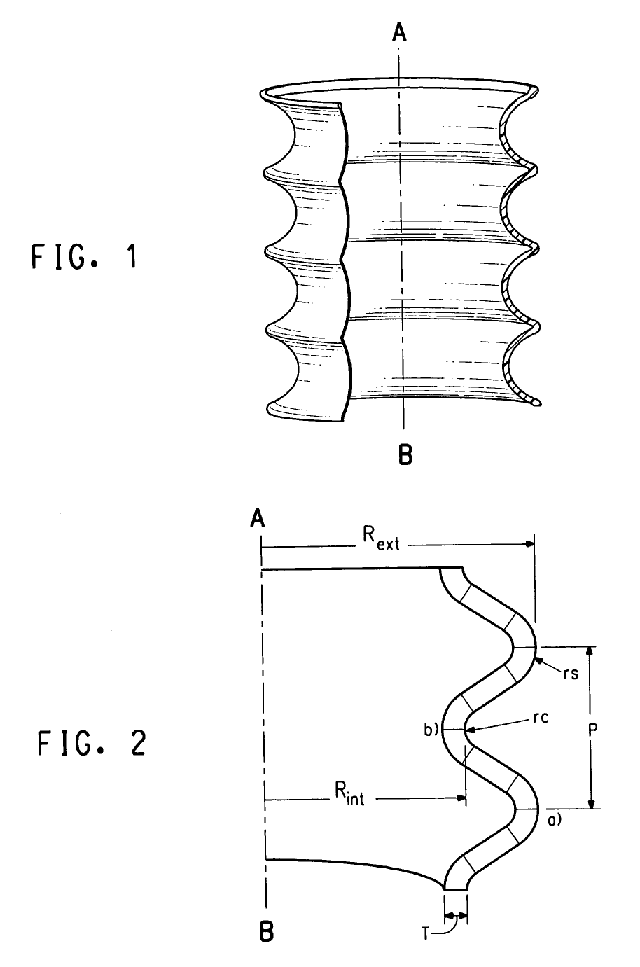

In comparison with jounce bumpers made by conventional techniques like extrusion/injection blow molding, articles made in accordance with the present invention are not only simple and cost-effective to produce in a continuous process but are also of high quality in terms of well defined and controlled dimensions and excellent performance characteristics. Moreover, the design possibilities of jounce bumpers made by corrugated extrusion according to the present invention, such as for example the height of convolutes, the dimensions of the external diameter or the dimensions of the internal diameter, can be easily varied, leading to a faster start-up process in the event of redesign in comparison with conventional techniques. The geometry of the jounce bumper according to the present invention may be modified to fine tune the mechanical properties and the energy absorption performance for particular applications. Preferably, the jounce bumper according to the present invention has an axial force at maximum compression between at or about 10 and at or about 20 kN. Also preferably, the jounce bumper according to the present invention has a compressibility under an axial force at maximum compression between at or about 30% and at or about 90%, preferably between at or about 70% and at or about 80%, measured as (compressed height/uncompressed height)×100%. Modifications of the jounce bumper according to the present invention may involve, for example, varying uniformly or not the wall thickness of the jounce bumper (FIG. 2, T), varying the ratio of the diameter of the peaks to the diameter of the valleys by means of varying the diameter/radius of the peaks (FIG. 2, Rₑₓₜ) and diameter/radius of the valleys (FIG. 2, Rᵢₙₜ), by varying the number of bellows/convolutes, by varying the pitch or by varying the fillet radius at minimum outer diameter of bellows (FIG. 2, rc) and the fillet radius at maximum outer diameter of bellows (FIG. 2, rs). Any of these changes can be made relatively easily with the corrugated extrusion technique of the invention. The cross section form of the jounce bumper according to the present invention is not particularly limited, preferred forms are circular and/or elliptical forms. The jounce bumper according to the present invention can comprise circumferential corrugations, bellows or convolutes all along its length or can comprise corrugations, bellows or convolutes being interrupted by smooth regions.

Jounce bumpers of the present invention can be distinguished from conventional (i.e. cast or blow-molded) jounce bumpers in several ways.

a) Wall thickness uniformity and ratio diameters

If desired, the corrugated extrusion of materials into a jounce bumper shape results in pieces having sidewalls that are uniform in thickness. By uniform in thickness, it is meant a uniformity of the wall thickness of the jounce bumpers made from one jounce bumper to another one (reproducibility of the process), and a uniformity of the wall thickness within a single jounce bumper, e.g. along the whole circumference of the convolutes and a uniformity of the wall thickness of the jounce bumpers along the whole length of the article (when the jounce bumpers have a uniform wall thickness along the whole length of the piece). High uniformity of the wall thickness of the jounce bumper leads to better uniform deformation upon use, which results in improved jounce bumper properties like for example better mechanical properties, a more uniform rigidity and an increased lifetime. When a non-uniform wall thickness either along the whole circumference of the convolutes of a single jounce bumper or along the whole length of the article is desired, corrugated extrusion allows a high level of the control of the thickness.

Jounce bumpers are made in bellows form, having a plurality of circumferentially spaced peaks and valleys (see FIG. 2, a) peaks and b) valleys). Corrugated extrusion permits the manufacture of jounce bumpers having particularly high ratios of the diameter of the peaks to the diameter diameters of the valleys, i.e. ratio values higher than at or about 1.2. Such high ratios lead to deep convolutes allowing a high degree of flexibility. A combination of such ratios with a homogenous uniformity of wall thickness is not attainable with conventional techniques.

b) Broad Range of Materials

Conventional techniques, such as blow molding, require that the melt polymer should have an apparent melt viscosity measured according to ISO 11443:2005(E) higher than 350 Pa·s at a shear rate of 1000 s⁻¹ and at a processing temperature at or about 30° C. higher than the melting point of the polymer. Such high apparent melt viscosities are necessary with blow molding because the parison is freely suspended as it emerges from the die and must bear its own weight without being stretched or sagged in an uncontrollable fashion during this phase. This limits the materials that can be used to manufacture blow molded jounce bumpers. In contrast, a broad range of materials can be chosen to manufacture the jounce bumpers according to the method of the present invention.

The material which can be used in the method of the present invention is required to be flexible and fatigue resistant. Suitable examples of material used for the present invention include thermoplastic elastomers. In addition to the convenience of melt processability, thermoplastic elastomers are preferred for environmental reasons because they are recyclable. In contrast, thermosets and especially cross-linked polyurethanes or cross-linked rubbers which are conventionally used to prepare jounce bumpers cannot be recycled.

Thermoplastic elastomers useful for the present invention include those defined in ISO 18064:2003(E), such as thermoplastic polyolefinic elastomers (TPO), styrenic thermoplastic elastomers (TPS), thermoplastic polyether or polyester polyurethanes (TPU), thermoplastic vulcanizates (TPV), thermoplastic polyamide block copolymers (TPA), copolyester thermoplastic elastomers (TPC) such as copolyetheresters or copolyesteresters, and mixtures thereof; also suitable materials are thermoplastic polyesters and mixtures thereof.

The jounce bumper according to the present invention may also be made of a thermoplastic elastomer having an apparent viscosity higher than 275 Pa·s measured according to ISO 11443:2005(E) under a shear rate of 1000 s⁻¹ and at a processing temperature at or about 30° C. above the polymer melting point. Preferably the thermoplastic elastomer has an apparent viscosity higher than 300 Pa·s measured according to ISO 11443:2005(E) under a shear rate of 1000 s⁻¹ and at a processing temperature at or about 30° C. above the polymer melting point.

Thermoplastic polyolefinic elastomers (TPO's) consist of olefin type, like for example propylene or polyethylene, with a rubber. Common rubbers include EPR (ethylene-propylene rubber), EPDM (ethylene propylene diene rubber), ethylene-hexane, ethylene-octene (like for example Engage® which is commercially available from Dow) and ethylene-butadiene.

Styrenic thermoplastic elastomers (TPS's) consist of block copolymers of polystyrene and rubbery polymeric materials like for example polybutadiene, a mixture of hydrogenated polybutadiene and polybutadiene, poly(ethylene-propylene) and hydrogenated polyisoprene.

Thermoplastic polyurethanes (TPU's) consist of linear segmented block copolymer composed of hard comprising a diisocyanate a short chain glycol and soft segments comprising diisocyanate and a long chain polyol as represented by the general formula

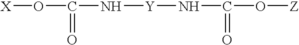

wherein

“X” represents a hard segment comprising a diisocyanate and a short-chain glycol, “Z” represents a soft segment comprising a diisocyanate and a long-chain polyol and “Y” represents the residual group of the diisocyanate compound of the urethane bond linking the X and Z segments. The long-chain polyol includes those of a polyether type such as poly(alkylene oxide)glycol or those of polyester type.

Thermoplastic vulcanizates (TPV's) consist of a continuous thermoplastic phase with a phase of vulcanized elastomer dispersed therein. Vulcanizate and the phrase “vulcanizate rubber” as used herein are intended to be generic to the cured or partially cured, cross-linked or cross-linkable rubber as well as curable precursors of cross-linked rubber and as such include elastomers, gum rubbers and so-called soft vulcanizates. TPV's combine many desirable characteristics of cross-linked rubbers with some characteristics like processability of thermoplastic elastomers. There are several commercially available TPVs, for example Santoprene® and Sarlink® (TPV's based on ethylene-propylene-diene copolymer and polypropylene) which are respectively commercially available from Advanced Elastomer System's and DSM; Nextrile™ (TPV based on nitrile rubber and polypropylene) which is commercially available from Thermoplastic Rubber Systems; Zeotherm® (TPV based on acrylate elastomer and polyamide) which is commercially available from Zeon Chemicals; and DuPont™ ETPV from E. I. du Pont de Nemours and Company, which is described in WO 2004029155 (thermoplastic blends comprising from 15 to 60 wt-% of polyalkylene phthalate polyester polymer or copolymer and from 40 to 85 wt % of a cross-linkable poly(meth)acrylate or polyethylene/(meth)acrylate rubber dispersed phase, wherein the rubber is dynamically cross-linked with a peroxide free radical initiator and an organic diene co-agent).

Thermoplastic polyamide block copolymers (TPA's) consist of linear and regular chain of polyamide segments and flexible polyether or polyester segments or soft segment with both ether and ester linkages as represented by the general formula

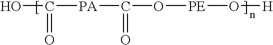

wherein
“PA” represents a linear saturated aliphatic polyamide sequence and “PE” represents for example a polyoxyalkylene sequence formed from linear or branched aliphatic polyoxyalkylene glycols or a long-chain polyol with either ether or ester or both linkages and mixtures thereof or copolyethers copolyesters derived therefrom. The softness of the copolyetheramide or the copolyesteramide block copolymer generally decreases as the relative amount of polyamide units is increased.
Suitable examples of thermoplastic polyamide block copolymers for use in the present invention are commercially available from Arkema or Elf Atochem under the trademark Pebax®.

For an excellent balance of grease resistance, high temperature durability and low temperature flexibility, the jounce bumper according to the present invention may be made from thermoplastic polyester compositions. Preferred thermoplastic polyesters are typically derived from one or more dicarboxylic acids (where herein the term “dicarboxylic acid” also refers to dicarboxylic acid derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I); 1,4-cyclohexanedimethanol; HO(CH₂CH₂O)ₘCH₂CH₂OH (II); and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they do not have to be integers. Other dicarboxylic acids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(trimethylene terephthalate) (PTT), poly(1,4-butylene terephthalate) (PBT), poly(ethylene 2,6-naphthoate), and poly(1,4-cyclohexyldimethylene terephthalate) (PCT). Preferably, thermoplastic polyesters useful for the present invention further contain impact modifier and/or plasticizer.

Copolyester thermoplastic elastomers (TPC) such as copolyetheresters or copolyesteresters are copolymers that have a multiplicity of recurring long-chain ester units and short-chain ester units joined head-to-tail through ester linkages, said long-chain ester units being represented by formula (A):

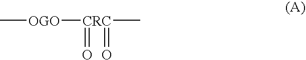

and said short-chain ester units being represented by formula (B):

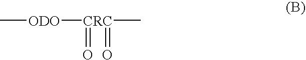

wherein
G is a divalent radical remaining after the removal of terminal hydroxyl groups from poly(alkylene oxide)glycols having preferably a number average molecular weight of between about 400 and about 6000; R is a divalent radical remaining after removal of carboxyl groups from a dicarboxylic acid having a molecular weight of less than about 300; and D is a divalent radical remaining after removal of hydroxyl groups from a diol having a molecular weight preferably less than about 250; and wherein said copolyetherester(s) preferably contain from about 15 to about 99 wt-% short-chain ester units and about 1 to about 85 wt-% long-chain ester units.
As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

The term “short-chain ester units” as applied to units in a polymer chain of the copolyetheresters refers to low molecular weight compounds or polymer chain units. They are made by reacting a low molecular weight diol or a mixture of diols with a dicarboxylic acid to form ester units represented by Formula (B) above. Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, and a more preferred diol is 1,4-butanediol.

Copolyetheresters that have been advantageously used for the manufacture of the jounce bumper of the present invention are commercially available from E. I. du Pont de Nemours and Company, Wilmington, Del. under the trademark Hytrel®.

According to a preferred embodiment, jounce bumpers according to the present invention are made of copolyester thermoplastic elastomers (TPC) such as copolyetheresters or copolyesteresters, and mixture thereof.

The material used to manufacture the jounce bumpers according to the present invention may comprise other additives including plasticizers; stabilizers; antioxidants; ultraviolet absorbers; hydrolytic stabilizers; anti-static gents; dyes or pigments; fillers, fire-retardants; lubricants; reinforcing agents such as fibers, flakes or particles of glass; minerals, ceramics, carbon among others, including nano-scale particles; processing aids, for example release agents; and/or mixtures thereof. Suitable levels of these additives and methods of incorporating these additives into polymer compositions are known to those of skill in the art.

c) Surface Vacuum Slots

Surface vacuum slot marks are visible on the outer surface of the parts made by vacuum corrugation as circumferential or helical raised ridges. Vacuum slots are present on the inner surface of the mold, and allow the molten material to be sucked up to shape of the mold by vacuum.

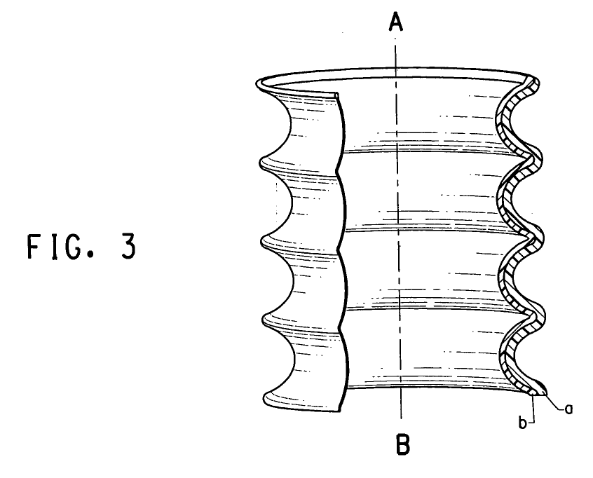

The method of the invention permits the manufacture of multilayer jounce bumpers (see FIG. 3). The extruded tube is first formed by co-extrusion of two or more desired materials in concentric layers. The process is similar to the process described above for monolayer structures, except that the extrusion head is designed to distribute the several layers of material in the wall thickness of the part. The plastic materials are extruded in a hot moldable state through the pin and the die of an extrusion head. The pin and the die are positioned inside the two halved of the mold blocs of the corrugating equipment. When the molten materials coming from the extrusion head reach the mold blocs, it is drawn up (sucked up) to the shape of the mold by vacuum. The mold blocs are in movement versus the pin and the die head, which allow producing continuously multilayer jounce bumpers at a rather elevated speed.

Multilayer structure are designed to optimize the properties of the jounce bumpers by taking advantage of the structure itself but also by placing different materials at the most appropriate position in the part.

The choice of the material to be used for manufacturing jounce bumper made of a multilayer structure is related to adhesion requirement in between the layers, to rigidity requirement, to fatigue resistance, to cost manufacturing requirements, to chemical or physical resistance requirements due to the external environment of the jounce bumpers and to integration of additional functionality such as dust protection. The thickness of each layer is chosen according to the material itself but also by the same requirements described above concerning the material.

A multilayer structure jounce bumper according to the present invention comprises at least two (i.e. two, three, four, etc.) layers. In a two or three layer jounce bumper, at least one layer made of a thermoplastic elastomer and preferably from the list of thermoplastic elastomers described above. The at least one layer made of thermoplastic elastomer may be used as a layer that is adjacent to another layer, may be used as a middle layer comprised between an inner and outer layer leading to a multilayer structure consisting of at least two other layers sandwiching the one or more middle layers made of thermoplastic elastomer, or may be used as an outer layer that is adjacent to another layer. Other layers of the multilayer structure may be used in order to confer stiffness and/or rigidity or others functionalities to the final structure.

In a preferred structure of the jounce bumper according to the present invention, the multilayer structure is made of at least three layers consisting of an inner layer and an outer layer made of a deformable elastomer as previously described sandwiching one or more rigid polymer layers. An example of jounce bumper having three layers have the following wall thickness repartition: (outer/middle/inner) 40%/20%/40% or 30%/40%/30%, wherein the inner and outer layers are made of a deformable elastomer and the middle layer is made of a polymer which is more rigid than the one(s) used for the external layers.

Should the adhesion between the polymeric layers be insufficient, one or more adhesive layers can be added between the polymeric layers.

### EXAMPLES

The following material was used for preparing monolayer jounce bumpers according to the present invention:

The following copolyetherester composition was polymerized. It contained 35 wt-% of poly(tetramethylene oxide) having an average molecular weight of about 1000 as polyether block segments, the weight percentage being based on the total weight of the copolyetherester composition. The short chain ester units were polybutylene terephthalate segments. The melting point of the copolyetherester composition was 200° C. and the hardness was 55 shore D. Such a product is commercially available from E.I. DuPont de Nemours and Company, Wilmington, Del., USA.

Five jounce bumpers made of the copolyetherester described above were manufactured as follows:

Pellets of a copolyetherester polymer were fed into a single extruder (Maillefer S A, Switzerland) having barrel temperatures set at about 220° C. to about 240° C. The tubular die (diameter of the die: 22.4 mm, diameter of the pin: 13.7 mm) and the connecting pipes were set at 240° C. After extrusion, the molten plastic extruded tube was corrugated in a vacuum (0.8 bar) corrugator (Corelco, France) at a line speed of 4 m/min (this corresponds to about 40 jounces bumpers manufactured per minute; in comparison, blow molding allows the manufacture of about 4 jounce bumpers per minute). The mold tunnel comprising the mold blocks was cooled at 10-12° C. by water. The chain of multiple jounce bumpers was continuously fed into a cutter which cut the chain into single discrete jounce bumpers.

Mold dimensions are given in Table 1.

To determine piece-to-piece variability (reproducibility of the process), the wall thickness of five jounce bumpers according to the invention was measured. The jounce bumpers were made with the design described in Table 1, using the thermoplastic elastomer defined above. The wall thickness was measured for the first extruded convolute on each of the five jounce bumpers. The wall thickness varied by ±0.05 mm for an average wall thickness of 2.85 mm (variation of 1.75%).

TABLE 1
Design and characteristics of the mold used to manufacture the
jounce bumpers made by corrugated extrusion according to the present
invention.

| Shape | Cylindrical |
|---|---|
| | (same Rₑₓₜ along the piece, same Rᵢₙₜ along the |
| | piece) |
| Mold dimension | |
| Pitch [of bellows], mm | 15.6 |
| Rₑₓₜ, mm | 25 |
| Rᵢₙₜ, mm | 20 |
| rc, mm | 3 |
| rs, mm | 3 |
| number of convolutes | 5 |

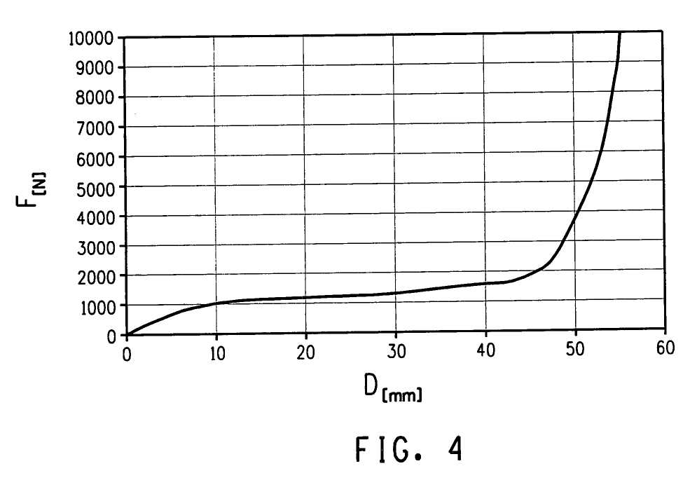

An extruded jounce bumper according to the present invention was made with the design described in Table 1, using the thermoplastic elastomer defined above. It had an average wall thickness of 2.2 mm. It was tested using the following procedure. The jounce bumper was put in between two plates of a tension-compression machine. The specimen was compressed at 23° C. at a constant speed of 50 mm/min. The upper load level of 10 kN corresponds to typical force exerted on a jounce bumper during extreme displacements of the suspension. The variation of force versus deflection was measured. The measured compression curve is presented in FIG. 4. The shape of the curve shows the performance desired for a jounce bumper.

1. A jounce bumper made of a thermoplastic elastomer, which thermoplastic elastomer has an apparent viscosity higher than 275 Pa·s measured according to ISO 11443:2005(E) under a shear rate of 1000 s⁻¹ and at a processing temperature at or about 30° C. above the polymer melting point.

2. The jounce bumper according to claim 1, wherein the thermoplastic elastomer has an apparent viscosity higher than 300 Pa·s measured according to ISO 11443:2005(E) under a shear rate of 1000 s⁻¹ and at a processing temperature at or about 30° C. above the polymer melting point.

3. The jounce bumper according to claim 1 having an axial force at maximum compression between at or about 10 and at or about 20 kN.

4. The jounce bumper according to claim 1 having a compressibility under an axial force at maximum compression between at or about 30% and at or about 90%.

5. The jounce bumper according to claim 1 having on its surface vacuum slot marks.

6. A jounce bumper comprising multiple concentric layers of different materials.

7. The jounce bumper according to claim 6 which comprises at least two layers.

8. The jounce bumper according to claim 6 which comprises at least three layers.

9. The jounce bumper according to claim 6 which comprises multiple layers comprising one inner layer and one outer layer made of a thermoplastic elastomer layer sandwiching one or more rigid elastomeric polymeric middle layers.

10. The jounce bumper according to claim 6 which comprises multiple layers and one or more adhesive layers.

11. A method for manufacturing a jounce bumper comprising the steps of:
a) feeding a molten plastic material into an extruder;
b) extruding the plastic material, which is in a hot moldable condition, through the pin and the die of an extrusion head to form a hollow continuous tube;
c) corrugating the hollow continuous tube; and
d) cutting the chain of multiple jounce bumpers to form single and discrete jounce bumpers.

12. The method according to claim 11, wherein the step of corrugation is a vacuum corrugation.

13. The method according to claim 11, wherein the extrusion is carried out with a thermoplastic elastomer.

14. The method according to claim 11, wherein extrusion is carried out with a thermoplastic elastomer chosen among thermoplastic polyolefins (TPO), styrenic thermoplastic elastomers (TPS), thermoplastic polyether or polyester polyurethanes (TPU), thermoplastic vulcanizates (TPV), thermoplastic polyamide block copolymers (TPA), copolyester thermoplastic elastomers (TPC), thermoplastic polyesters and mixtures thereof.

15. The method according to claim 11, wherein the extrusion is carried out with a thermoplastic elastomer chosen among copolyetheresters or copolyesteresters and mixtures thereof.

16. The method according to claim 11, wherein the jounce bumper has an axial force at maximum compression between at or about 10 and at or about 20 kN.

17. The process according to claim 11, wherein the jounce bumper has a compressibility under an axial force at maximum compression between at or about 30% and at or about 90%.

18. The method according claim 11, wherein the extrusion comprises extruding at least two concentric layers.
